(19) United States
(12) Patent Application Publication
(10) Pub. No.: US 2014/0272368 A1
(43) Pub. Date: Sep. 18, 2014

(54) CELLULOSE DIESTER FILMS FOR PLAYING CARDS

(71) Applicant: Celanese Acetate LLC, Irving, TX (US)

(72) Inventor: Steve Herod, Spondon (GB)

(73) Assignee: Celanese Acetate LLC, Irving, TX (US)

(21) Appl. No.: 14/206,047

(22) Filed: Mar. 12, 2014

Related U.S. Application Data
(60) Provisional application No. 61/779,475, filed on Mar. 13, 2013.

(51) Int. Cl. C08K 5/12; C08K 5/521; C08K 5/3417; B41M 3/00; C08K 5/357; C08K 3/22; C08K 3/30; C08K 3/04; C08K 5/11; C08K 5/3437

(52) U.S. Cl. CPC C08K 5/12; C08K 5/11; C08K 5/521; C08K 5/3417; C08K 5/3437; C08K 5/357; C08K 3/22; C08K 3/30; C08K 3/04; B41M 3/00
USPC 428/220; 106/170.31; 106/170.29; 106/170.16; 106/170.34; 106/170.1; 106/170.11; 427/289; 427/261; 427/322

(57) ABSTRACT

Cellulose diester films that include a cellulose diester; a plasticizer; a colorant; and an opacity additive may be useful for playing cards. In some instances, forming cellulose diester films may include preparing a dope that comprises a cellulose diester, a plasticizer, and a solvent; introducing a colorant and an opacity additive into the dope to yield a casting dope; and casting the casting dope into a cellulose diester film. Playing cards may then be produced by methods including, for example, cutting the cellulose diester film and printing on the cellulose diester film.

### BACKGROUND

The present invention relates to cellulose diester films for playing cards and methods relating thereto.

Playing-cards are used for playing a variety of games. Historically, playing-cards have been made of paper and laminated paper. More recently, polyvinyl chloride (“PVC”) has been used in making playing-cards. Typically PVC films are prepared and then printed on to yield PVC playing cards.

However, PVC playing-cards have several drawbacks that often require additional considerations in the manufacturing process. For example, PVC has a low moisture vapor transfer rate that causes the card to stick together in a high humidity environment or when handled by sweaty hands. To mitigate this sticking tendency, coatings have been applied to the PVC. In another example, PVC playing cards, are much less durable and can be easily marked due to a lack of strength in PVC, e.g., by creating an indentation, folding a corner, or creating a small tear. In yet another example, PVC has a relatively low opacity, which for use in playing cards means a thicker film or card needs to be produced to mitigate transparency.

### DETAILED DESCRIPTION

The present invention relates to cellulose diester films for playing cards and methods relating thereto.

Compared to PVC playing cards, cellulose diester playing cards may advantageously have better properties that allow for the production of higher quality playing cards. For example, cellulose diester playing cards (or playing cards comprising cellulose diester films) may have higher strength and durability that prevent card marking. Further, cellulose diester playing cards also may have a moisture vapor transfer rate greater than PVC films, which provides less sticking of the cards to each other and surfaces in high humidity conditions. Additionally, the cellulose diester films described herein have a high capacity for additives, including those that provide for increased opacity. Therefore, a thinner, more opaque playing card may be produced than with previous methods and compositions such as PVC.

It should be noted that when “about” is provided herein in reference to a number in a numerical list, the term “about” modifies each number of the numerical list. It should be noted that in some numerical listings of ranges, some lower limits listed may be greater than some upper limits listed. One skilled in the art will recognize that the selected subset will require the selection of an upper limit in excess of the selected lower limit.

In some embodiments, cellulose diester playing cards described herein may comprise a cellulose diester film. A cellulose diester film described herein may, in some embodiments, comprise cellulose diester, a plasticizer, a colorant, and an opacity additive.

As used herein, the term “cellulose diester” refers to cellulose derivatized with ester moieties with a degree of substitution of about 2.2 to about 2.7. Suitable cellulose diesters for use as described herein may include, but are not limited to, cellulose diacetate, cellulose dibutyrate, cellulose dipropionate, cellulose di(acetate butyrate), cellulose di(acetate propionate), cellulose di(butyrate propionate), cellulose di(acetate butyrate propionate), and the like, and any combination thereof.

Plasticizers may be useful in tailoring the softness and flexibility of the playing cards. Suitable plasticizers for use as described herein may include, but are not limited to, glycerol triacetate (triacetin), triethyl citrate, dimethoxy-ethyl phthalate, dimethyl phthalate, diethyl phthalate, methyl phthalyl ethyl glycolate, o-phenyl phenyl-(bis) phenyl phosphate, 1,4-butanediol diester, diester, dipropionate ester of triethylene glycol, dibutyrate ester of triethylene glycol, dimethoxyethyl phthalate, triethyl citrate, triacetyl glycerin, and the like, any derivative thereof, and any combination thereof.

In some embodiments, plasticizers may be included in the cellulose diester films described herein in an amount ranging from a lower limit of about 15%, 20%, or 23% by weight of the cellulose diester film to an upper limit of about 30%, 25%, or 20% by weight of the cellulose diester film, wherein the amount may range from any lower limit to any upper limit and encompasses any subset therebetween.

Colorants may be useful for coloring the playing card, e.g., to provide a background color. Suitable colorants for use as described herein may include, but are not limited to, titanium dioxide, silicon dioxide, tartrazine, phthalocyanine blue, phthalocyanine green, quinacridones, perylene tetracarboxylic acid di-imides, dioxazines, perinones disazo pigments, anthraquinone pigments, carbon black, metal powders, iron oxide, ultramarine, calcium carbonate, kaolin clay, aluminum hydroxide, barium sulfate, zinc oxide, aluminum oxide, CARTASOL® dyes (cationic dyes, available from Clariant Services) in liquid and/or granular form (e.g., CARTASOL® Brilliant Yellow K-6G liquid, CARTASOL® Yellow K-4GL liquid, CARTASOL® Yellow K-GL liquid, CARTASOL® Orange K-3GL liquid, CARTASOL® Scarlet K-2GL liquid, CARTASOL® Red K-3BN liquid, CARTASOL® Blue K-5R liquid, CARTASOL® Blue K-RL liquid, CARTASOL® Turquoise K-RL liquid/granules, CARTASOL® Brown K-BL liquid), FASTUSOL® dyes (an auxochrome, available from BASF) (e.g., Yellow 3GL, Fastusol C Blue 74L), D&C colors (available from Keystone Colours) (e.g., D&C Red #28, D&C Orange #4, D&C Yellow #8, D&C Yellow #10, D&C Green #5, D&C Green #8, and D&C Green #6), inorganic pigments (e.g., Pigment Yellow 42, Pigment Yellow 147, Pigment Yellow HG (PY191:1), Pigment Red 48:2, Pigment Red 53:1, Pigment Red 57:1, Pigment Red 101, Pigment Red 122, Pigment Red 254, Pigment Violet 23, Pigment Blue 15, Pigment Blue 15:1, Pigment Blue 15:3, Pigment Green 7, Pigment Black 7, Pigment Black 11, and Pearlescent Fine Gold, available from Unicolour), natural pigments (e.g., Turmeric/Curcumin E100, Riboflavin E101, Lutein E161b, Beta Cartotenes/Carotenoids E160a, Annatto E160b, Paprika E160c, Lycopene E160d, Cochineal/Carmine E120, Beetroot Red E162, Anthocyanin E163, Chlorophyll E140/E141, Caramel/Malt E150, Carbo Vegetabais E153, Titanimum Dioxide E171, and Iron Oxides E172, available from Unicolour), and the like, and any combination thereof.

In some embodiments, colorants may be included in the cellulose diester films described herein in an amount ranging from a lower limit of about 1%, 2%, or 5% by weight of the cellulose diester film to an upper limit of about 20%, 15%, or 10% by weight of the cellulose diester film, wherein the amount may range from any lower limit to any upper limit and encompasses any subset therebetween.

Opacity additives may be useful in tailoring the opacity of the playing cards. Suitable opacity additives for use as described herein may include, but are not limited to, silver pigments. Examples of commercially available silver pigments include METASHEEN (available from Ciab) and MIRAL (available from Metal Powders).

In some embodiments, opacity additives may be included in the cellulose diester films described herein in an amount ranging from a lower limit of about 0.1%, 0.5%, or 0.75% by weight of the cellulose diester film to an upper limit of about 2.5%, 1.5%, or 1% by weight of the cellulose diester film, wherein the amount may range from any lower limit to any upper limit and encompasses any subset therebetween.

In some embodiments, the cellulose diester films described herein may be produced by casting methods. Some embodiments may involve preparing a dope that comprises cellulose diester, plasticizer, a solvent, colorants, and opacity additives; and casting the dope into a cellulose diester film. Some embodiments may involve preparing a dope that comprises cellulose diester, plasticizer, and a solvent; introducing colorants and opacity additives into the dope to yield a casting dope; and casting the casting dope into a cellulose diester film. It should be noted that the term “casting dope” is used herein for clarity and should not be taken as limiting as to the composition, function, or processing requirements of the dope. In some embodiments, additional plasticizers may be introduced with the colorants and the opacity additives.

Examples of suitable solvents may include, but are not limited to, acetone, ethyl acetate, butanone, dichloromethane, methanol, water, and the like, and any combination thereof.

In some embodiments, casting a cellulose diester film may involve passing the casting dope through an extruder onto a surface to form a pre-film; and drying the pre-film to form the cellulose diester film. In some embodiments, casting may further include a second drying step to reduce the solvent content and moisture content in the cellulose diester film to desired levels. Cast cellulose diester films may be produced at a thickness of about 75 microns to about 200 microns, including any subset therebetween. One of ordinary skill in the art should recognize that thickness outside these ranges may be achieved.

In some embodiments, cellulose diester film described herein may be produced by extrusion methods. Some embodiments may involve mixing cellulose diester, plasticizer, colorants, and opacity additives; and applying heat and pressure to the mixture to yield a cellulose diester film. Extruded cellulose diester films for use as described herein may be produced at a thickness of about 20 microns, 50 microns, or 100 microns to about 2 mm, 1 mm, 500 microns, or 250 microns, and wherein the thickness may range from any lower limit to any upper limit and encompasses any subset therebetween. One of ordinary skill in the art should recognize that thickness outside these ranges may be achieved.

In some embodiments, cellulose diester films for use in cellulose diester playing cards may advantageously be about 300 microns thick, which is similar to other playing cards. As such, the cellulose diester films produced at smaller thickness (e.g., via casting or extrusion methods) may be laminated to yield the desired thickness. Some embodiments may involve laminating a cellulose diester film at least once to yield the cellulose diester film at a thickness suitable for use in preparing cellulose diester playing cards (e.g., once for about 150 micron thick cellulose diester films, twice for about 75 micron thick cellulose diester films, and so on). One skilled in the art with the benefit of this disclosure should understand that other thicknesses of cellulose diester playing cards may be desired and are within the scope of this disclosure, including any adjustments to the methods described herein to achieve such a thickness. For example, desirable cellulose diester playing card thicknesses may range from a lower limit of about 75 microns, 100 microns, 150 microns, or 200 microns to an upper limit of about 500 microns, 400 microns, or 300 microns, wherein the thickness may range from any lower limit to any upper limit and encompasses any subset therebetween.

Some embodiments may involve cutting the cellulose diester films into rolls with a suitable width or sheets with a suitable height and width for printing playing cards.

One of ordinary skill in the art should recognize the plurality of methods available for producing cellulose diester playing cards from cellulose diester films described herein. For example, some embodiments may involve printing on the cellulose diester film (e.g., in rolls or sheets) so as to yield cellulose diacetate playing cards. In some embodiments, printing may involve priming the cellulose diester film; printing on the primed cellulose diester film; and optionally coating the printed cellulose diester film. In some instances, printing may be with UV-curable inks so as to advantageously mitigate bleeding or degradation of the ink.

In some embodiments, a pack of playing cards may comprise at least one cellulose diester playing card described herein.

In some embodiments, the methods and compositions described herein may be utilized for producing cellulose diester films suitable for use in other application, e.g., as window shades, blackout blinds, window covering, window tints, labels, and the like. One of ordinary skill in the art should understand the modifications to the compositions and methods described herein to allow for these applications. For example, blackout blinds may have a thickness of about 150 microns or greater and comprise a black pigment. As such, cellulose diester films described herein may be produced (e.g., via casting or extrusion methods, optionally in combination with laminating methods) at thickness ranging from a lower limit of about 20 microns, 50 microns, 75 microns, 100 microns, 150 microns, or 200 microns to an upper limit of about 2 mm, 1 mm, 500 microns, 400 microns, or 300 microns, wherein the thickness may range from any lower limit to any upper limit and encompasses any subset therebetween.

Embodiments disclosed herein include:
A: a playing card comprising a cellulose diester film that comprises a cellulose diester; a plasticizer; a colorant; and an opacity additive;
B: for a method comprising preparing a dope that comprise a cellulose diester, a plasticizer, and a solvent; introducing a colorant and an opacity additive into the dope to yield a casting dope; and casting the casting dope into a cellulose diester film; and
C: a method comprising providing a cellulose diacetate film comprising a cellulose diester, a plasticizer, a colorant, and an opacity additive; and printing on the cellulose diacetate film so as to yield cellulose diester playing cards.

Each of embodiments A, B, and C may independently have one or more of the following additional elements in any combination: Element 1: the plasticizer being present in an amount of about 15% to about 30% by weight of the cellulose diester film Element 2: the colorant being present in an amount of about 1% to about 20% by weight of the cellulose diester film; Element 3: the opacity additive being present in an amount of about 0.1% to about 2.5% by weight of the cellulose diester film; Element 4: the plasticizer comprising at least one selected from the group consisting of triacetin, triethyl citrate, dimethoxy-ethyl phthalate, dimethyl phthalate, diethyl phthalate, methyl phthalyl ethyl glycolate, o-phenyl phenyl-(bis) phenyl phosphate, 1,4-butanediol diester, diester, dipropionate ester of triethylene glycol, dibutyrate ester of triethylene glycol, dimethoxyethyl phthalate, triethyl citrate, triacetyl glycerin, any derivative thereof, and any combination thereof; Element 5: the colorant comprising at least one selected from the group consisting of titanium dioxide, silicon dioxide, tartrazine, phthalocyanine blue, phthalocyanine green, quinacridones, perylene tetracarboxylic acid di-imides, dioxazines, perinones disazo pigments, anthraquinone pigments, carbon black, metal powders, iron oxide, ultramarine, calcium carbonate, kaolin clay, aluminum hydroxide, barium sulfate, zinc oxide, aluminum oxide, an inorganic pigment, a natural pigment, and any combination thereof; Element 6: the opacity additive comprising a silver pigment; and Element 7: the cellulose diester film has a thickness of about 75 microns to about 500 microns (or any subset therebetween, e.g., about 250 microns to about 350 microns).

Embodiment B may have one or more of the following additional elements in any combination: Element 8: introducing a second plasticizer with the colorant and the opacity additive; Element 9: cutting the cellulose diester film to a width, height, or both suitable for printing playing cards; and Element 10: printing on the cut cellulose diacetate film so as to yield cellulose diester playing cards. Embodiment C may have any elements of embodiment B or an additional elements thereof as a portion of the providing a cellulose diacetate film.

By way of non-limiting example, exemplary combinations independently applicable to A, B, and C include: at least two of Elements 1, 2, 3, and 7 in combination; Element 6 in combination with at least one of Elements 1, 2, 3, and 7; Element 1 in combination with Element 4; Element 2 in combination with Element 5; Element 3 in combination with Element 6; Element 7 in combination with the foregoing, unless otherwise provide for; and so on.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A cellulose diester film comprising:
a cellulose diester;
a plasticizer;
a colorant; and
an opacity additive.

2. The cellulose diester film of claim 1, wherein the plasticizer is present in an amount of about 15% to about 30% by weight of the cellulose diester film.

3. The cellulose diester film of claim 1, wherein the colorant is present in an amount of about 1% to about 20% by weight of the cellulose diester film.

4. The cellulose diester film of claim 1, wherein the opacity additive is present in an amount of about 0.1% to about 2.5% by weight of the cellulose diester film.

5. The cellulose diester film of claim 1, wherein the plasticizer comprises at least one selected from the group consisting of triacetin, triethyl citrate, dimethoxy-ethyl phthalate, dimethyl phthalate, diethyl phthalate, methyl phthalyl ethyl glycolate, o-phenyl phenyl-(bis) phenyl phosphate, 1,4-butanediol diester, diester, dipropionate ester of triethylene glycol, dibutyrate ester of triethylene glycol, dimethoxyethyl phthalate, triethyl citrate, triacetyl glycerin, any derivative thereof, and any combination thereof.

6. The cellulose diester film of claim 1, wherein the colorant comprises at least one selected from the group consisting of titanium dioxide, silicon dioxide, tartrazine, phthalocyanine blue, phthalocyanine green, quinacridones, perylene tetracarboxylic acid di-imides, dioxazines, perinones disazo pigments, anthraquinone pigments, carbon black, metal powders, iron oxide, ultramarine, calcium carbonate, kaolin clay, aluminum hydroxide, barium sulfate, zinc oxide, aluminum oxide, an inorganic pigment, a natural pigment, and any combination thereof.

7. The cellulose diester film of claim 1, wherein the opacity additive comprises a silver pigment.

8. The cellulose diester film of claim 1, wherein the cellulose diester film has a thickness of about 75 microns to about 500 microns.

9. A playing card comprising the cellulose diester film according claim 1.

10. A method comprising:
preparing a dope that comprises a cellulose diester, a plasticizer, and a solvent;
introducing a colorant and an opacity additive into the dope to yield a casting dope; and
casting the casting dope into a cellulose diester film.

11. The method of claim 10 further comprising:
introducing a second plasticizer with the colorant and the opacity additive.

12. The method of claim 10, wherein the plasticizer is present in an amount of about 15% to about 30% by weight of the cellulose diester film.

13. The method of claim 10, wherein the colorant is present in an amount of about 1% to about 20% by weight of the cellulose diester film.

14. The method of claim 10, wherein the opacity additive is present in an amount of about 0.1% to about 2.5% by weight of the cellulose diester film.

15. The method of claim 10, wherein the plasticizer comprises at least one selected from the group consisting of triacetin, triethyl citrate, dimethoxy-ethyl phthalate, dimethyl phthalate, diethyl phthalate, methyl phthalyl ethyl glycolate, o-phenyl phenyl-(bis) phenyl phosphate, 1,4-butanediol diester, diester, dipropionate ester of triethylene glycol, dibutyrate ester of triethylene glycol, dimethoxyethyl phthalate, triethyl citrate, triacetyl glycerin, any derivative thereof, and any combination thereof.

16. The method of claim 10, wherein the colorant comprises at least one selected from the group consisting of titanium dioxide, silicon dioxide, tartrazine, phthalocyanine blue, phthalocyanine green, quinacridones, perylene tetracarboxylic acid di-imides, dioxazines, perinones disazo pigments, anthraquinone pigments, carbon black, metal powders, iron oxide, ultramarine, calcium carbonate, kaolin clay, aluminum hydroxide, barium sulfate, zinc oxide, aluminum oxide, an inorganic pigment, a natural pigment, and any combination thereof.

17. The method of claim 10, wherein the opacity additive comprises a silver pigment.

18. The method of claim 10, wherein the cellulose diester film has a thickness of about 75 microns to about 500 microns.

19. The method of claim 10 further comprising:
cutting the cellulose diester film to a width, height, or both suitable for printing playing cards.

20. A method comprising:
providing a cellulose diacetate film comprising a cellulose diester, a plasticizer, a colorant, and an opacity additive; and
printing on the cellulose diacetate film so as to yield cellulose diester playing cards.
